(19) United States
(12) Patent Application Publication
(10) Pub. No.: US 2026/0151763 A1
(43) Pub. Date: Jun. 4, 2026

(54) PIPETTE ASSEMBLY

(71) Applicant: INTEGRA Biosciences AG, Zizers (CH)

(72) Inventors: Urs EGGER, Kaltbrunn (CH); Marlene FRANK, Bonaduz (CH)

(73) Assignee: INTEGRA Biosciences AG, Zizers (CH)

(21) Appl. No.: 19/122,364

(22) PCT Filed: Oct. 24, 2023
(86) PCT No.: PCT/EP2023/079526

§ 371 Date: Apr. 18, 2025

(30) Foreign Application Priority Data
Oct. 27, 2022 (EP) 22204175.8

(51) Int. Cl. B01L 3/00; B01L 3/02; B05B 1/18

(52) U.S. Cl. CPC B01L 3/0227; G01N 1/14; B01L 2200/087; B01L 2300/0663; B01L 2400/0478; G01N 2001/1427

(57) ABSTRACT

A pipette assembly having a pipetting unit having a pipette housing with a cylinder chamber and a pipetting opening, as well as a piston moveably mounted in a cylinder chamber, and a drive unit that acts on the piston, wherein the drive unit has a mode switch that can be shifted from a manual mode position into a stepwise mode position such that, when the mode switch is in the manual mode position, the actuation element can be actuated in a manual actuation mode, such that a pipetting volume can be output that is proportional to the movement of the actuation element, and when the mode switch is in the stepwise mode position, the actuation element can be actuated in a stepwise actuation mode in such a way that a determined pipetting volume is output for each actuation of the actuation element.

### TECHNICAL FIELD

The present invention relates to a pipette assembly as claimed in the independent claims.

### PRIOR ART

The prior art discloses pipettes for metering liquids. The pipettes have a cylinder and a piston which can move in the cylinder and with which the liquid can be drawn and dispensed in a metered manner.

EP 0 576 967 has disclosed a pipette with a mechanical actuation element which is moved by the user. The movement is then detected by sensors and the piston is moved via a piston drive on the basis of the sensor values detected. Here, the piston can be actuated continuously for dispensing liquid in relation to the movement of the actuation element or in steps for dispensing a determined volume for each actuation.

### SUMMARY OF THE INVENTION

Proceeding from this prior art, the invention is based on the object of specifying a pipette assembly which can be actuated ergonomically. This object is achieved by the subject matter of claim 1 and claim 16.

A pipette assembly as claimed in claim 1 comprises a pipetting unit and drive unit. The pipetting unit has a pipette housing with a cylinder chamber and a pipetting opening as well as a piston movably mounted in the cylinder chamber. The drive unit comprises a drive motor acting on the piston and moving the piston, an actuation element for specifying a movement of the piston, and a sensor assembly for detecting the movement of the actuation element and for providing a signal corresponding to the movement to the drive motor in such a way that the drive motor is controlled based on the signal and correspondingly acts on the piston. The drive unit also has a mode switch which can be shifted from a manual mode position to a stepwise mode position in such a way
that, when the mode switch is in the manual mode position, the actuation element can be actuated in a manual actuation mode in such a way that a pipetting volume which is proportional to the movement of the actuation element or which is proportional to the actuation travel of the actuation element can be dispensed, and
that, when the mode switch is in the stepwise mode position, the actuation element can be actuated in a stepwise actuation mode in such a way that a determined or identical pipetting volume is dispensed for each actuation.

A pipetting assembly of this kind provides laboratory personnel with a flexibly usable pipetting assembly. Owing to the switchover, the same actuation element can be used for both actuation modes, this having the ergonomic advantage that actuation can be performed in the same actuation direction.

The mode switch preferably limits the movement of the actuation element in the stepwise mode position. Limiting the movement of the actuation element for the stepwise actuation mode has the advantage that a determined movement of the actuation element can be performed, this improving the ergonomics of the pipetting assembly. The movement is preferably limited in the stepwise actuation mode in such a way that the user perceives the actuation as pushing of a push button.

In the manual actuation mode, the pipetting volume is proportional to the movement of the actuation element. That is to say, a volume corresponding to the actuation increment is dispensed for each actuation increment. The movement of the piston can correspond to the movement of the actuation element, or the movement of the piston can be stepped down or stepped up in relation to the movement of the actuation element.

The travel of the actuation element in the stepwise mode is preferably very small, so that the actuation does not require a large movement of the finger that actuates the actuation element. The travel of the actuation element in the stepwise mode preferably lies between 0.5 millimeter and 5 millimeters, in particular between 0.5 millimeter and 3 millimeters.

The mode switch can be shifted from the stepwise mode position to the manual mode position when returning from the stepwise mode.

The mode switch can be shifted from the manual mode position to the stepwise mode position and back by way of a user interaction.

The piston is, as mentioned, driven by the drive motor. Here, the drive motor moves the piston proportionally to the movement of the actuation element. Here, the movement of the actuation element can be transmitted to the piston, as mentioned, with a step up or a step down or with the same magnitude. When the piston moves away from the pipetting opening, a liquid can be drawn into the cylinder chamber through the pipetting opening, and when the piston moves in the direction of the pipetting opening, a liquid can be dispensed from the cylinder chamber through the pipetting opening.

The actuation element can preferably be moved from a first starting position to a first end position in the manual actuation mode and the actuation element can be moved from a second starting position to a second end position in the stepwise actuation mode.

In a first variant, the position of the first starting position is the same as the position of the second starting position, and the position of the first end position lies at a greater distance from the starting position than the position of the second end position.

In a second variant, the position of the first end position is the same as the position of the second end position, and the position of the first starting position lies at a greater distance from the end position than the position of the second starting position.

In a third variant, the position of the first starting position is different from the position of the second starting position and the position of the first end position is different from the position of the first starting position, wherein the position of the second starting position and the position of the second end position lies between the position of the first starting position and the first end position.

The actuation travel of the actuation element in the manual actuation mode is preferably greater than the movement travel of the actuation element in the stepwise actuation mode, this preferably being the case with the proviso that the movement travel of the actuation element in the stepwise actuation mode is greater than 0.5 millimeter. The actuation travel of the actuation element in the manual actuation mode is particularly preferably greater than the movement travel of the actuation element in the stepwise actuation mode by a factor of 3 to 6.

Consequently, the actuation movement by a finger of a user during the stepwise actuation mode turns out to be smaller than in the manual actuation mode. This has the advantage that the actuation is more ergonomic.

The actuation element is preferably movable along a respective movement travel both in the manual actuation mode and also in the stepwise actuation mode. The movement travel particularly preferably runs in the same direction in the manual actuation mode and in the stepwise actuation mode. The movement travel particularly preferably runs along a rectilinearly oriented axis in the manual actuation mode and in the stepwise actuation mode.

The movement of the actuation element both in the manual actuation mode and also in the stepwise actuation mode is advantageous because the user ergonomics can be improved. In both cases, the user receives haptic feedback due to the movement of the actuation element. In addition, the user can move the finger in both actuation modes and preferably apply approximately the same force in both actuation modes.

The movement of the actuation element both in the manual actuation mode and also in the stepwise actuation mode is advantageous because the user receives haptic feedback with each dispensing operation due to the movement. This haptic feedback indicates to the user that the dispensing operation was successful. The user can therefore continue with the dispensing process without being distracted by looking at a screen or another display device.

In the stepwise actuation mode, when a movement of the actuation element is detected by the sensor assembly when the actuation element is actuated, instead of the signal a predefined control signal is output to the drive motor in such a way that a predefined pipetting volume, which is independent of the actuation travel of the actuation element, can be dispensed.

The predefined pipetting volume is preferably set via an input element. For example via a mechanically actuable input element, such as a rotary ring or a slide, or via an electronic input element, such as a switch or a touchscreen.

A pipetting volume which is correlated to the movement travel of the actuation element or which is proportional to the movement travel of the actuation element is dispensed in the manual actuation mode.

The mode switch preferably has a mode switch-side stop surface. The actuation element preferably has an actuation element-side stop surface. When the mode switch is in the stepwise mode position, the mode switch-side stop surface is situated in such a way that the actuation element-side stop surface stops against the mode switch-side stop surface. When the mode switch is in the manual mode position, in a first variant the mode switch-side stop surface is situated in such a way that the actuation element-side stop surface can be moved freely past the mode switch-side stop surface or can be moved without interaction with the actuation element-side stop surface. When the mode switch is in the manual mode position, in a second variant the mode switch-side stop surface is situated in such a way that the actuation element-side stop surface stops against the mode switch-side stop surface only in an upper end position of the actuation element.

In other words, the mode switch provides a mechanical stop against which the actuation element can stop when the mode switch lies in the position for stepwise actuation.

The actuation element preferably has an actuation element-side actuation surface and the mode switch has a mode switch-side actuation surface. When the actuation element is unactuated and the mode switch is preferably in the manual mode position, the mode switch-side actuation surface lies at a distance of at most 80 millimeters from the actuation element-side actuation surface, as seen in the direction of the actuation movement of the actuation element. The distance particularly preferably lies between 40 and 70 millimeters. The distance is to be understood in the direction of the movement axis of the actuation element. The distance is advantageous because a user can operate the pipette assembly with one hand and can switch to and from between the two modes using one hand.

The pipette assembly preferably comprises a further sensor assembly. The further sensor assembly has a sensor, wherein the sensor is configured and arranged in such a way that the position of the mode switch can be detected, and that a control signal corresponding to the position can be provided to the drive motor. The control signal can be processed by the drive motor, for example, such that the drive motor processes the signal from the sensor assembly for detecting the movement of the actuation element differently between the two operating modes.

The sensor of the further sensor assembly is particularly preferably an electrical switch which is mechanically actuated by the mode switch. Other sensors, such as inductive sensors, capacitive sensors, optoelectronic sensors or magnetic field sensors, can also be used.

The pipette assembly preferably also has at least one printed circuit board which is arranged laterally adjacent to the drive motor.

Said sensor assembly for detecting the movement of the actuation element preferably has an active sensor element and a passive sensor element, wherein the active sensor element is arranged on the printed circuit board and the passive sensor element is arranged on the actuation element. Actuation of the actuation element results in a relative shift between the two sensor parts, which relative shift can be detected by the active sensor part. The active sensor element is preferably an inductive sensor and the passive sensor element is preferably composed of metal, with said relative shift resulting in a change in magnetic field that can be detected by the active sensor part. As an alternative, an optoelectronic sensor could also be used for position measurement.

The sensor of the further sensor assembly is preferably also arranged on said printed circuit board.

In a first embodiment, the mode switch can be shifted from the manual mode position to the stepwise mode position in a direction virtually parallel or parallel to the actuation direction of the actuation element. This embodiment has the advantage that a user can operate the pipette assembly using one hand.

The expression “virtually parallel” also includes a direction with a small angular offset in relation to the actuation direction of the actuation element.

The mode switch-side stop surface can preferably be shifted in said direction, and the mode switch-side stop surface provides a stop for the actuation element both in the first starting position for the manual actuation mode and also in the second starting position for the stepwise actuation mode.

When the mode switch is actuated, the mode switch-side stop surface can preferably be brought into contact with the actuation element-side stop surface. Owing to this contact, the actuation element can be moved from a starting position for the manual actuation mode to a starting position for the stepwise actuation mode. In other words, the actuation element is moved from the abovementioned first starting position for the manual actuation mode to the abovementioned second starting position for the stepwise actuation mode by the movement of the mode switch. Simple and ergonomic switchover can be performed as a result. In particular, the switchover can be performed using one hand.

In a second embodiment, the mode switch can be shifted from the manual mode position to the stepwise mode position in a direction virtually transverse or transverse to the actuation direction of the actuation element.

The expression “virtually transverse” also includes a direction with a small angular offset transverse to the actuation direction of the actuation element.

The mode switch preferably has a rod-like portion which engages into a corresponding opening on the actuation element, wherein the corresponding opening has an extent in the direction of actuation of the actuation element that is greater than the cross section of the rod-like portion.

In another embodiment, the mode switch can be shifted from the manual mode position to the stepwise mode position in a direction inclined in an angled manner in relation to the actuation direction of the actuation element.

In a third embodiment, the mode switch is a rotary disk. The rotary disk has a first groove and a second groove. The second groove runs inclined in an angled manner in relation to the first groove. The actuation element further has a pin which projects into the grooves. The grooves have different lengths in such a way that said movement limiting can be provided.

The rotary disk can pivot about a rotation axis which runs transverse to the direction of actuation of the actuation element.

The angle between the two grooves specifies a pivot angle for the rotary disk in such a way that the grooves run parallel to the direction of actuation of the actuation element in the respective mode position. The grooves intersect at the center of rotation of the rotary disk and when the pin lies at the point of intersection the rotary disk can be shifted from the manual mode position to the stepwise mode position.

In a fourth embodiment, the mode switch has a rigid shaft which engages into a receptacle arranged on the actuation element, wherein the receptacle has a region for the manual actuation mode and a region for the stepwise actuation mode, wherein the two regions can be brought into an interacting position with the shaft by pivoting the actuation element about the axis along which the actuation element is actuated.

Further optional features of the pipette assembly which can optionally be used for all variants are described below.

The mode switch can preferably be latched with respect to the drive unit via a latching element in the manual mode position. The mode switch can preferably be latched with respect to the drive unit and/or with respect to the actuation element via a latching element in the stepwise mode position.

The drive unit preferably also has a spring-elastic return element. The return element acts on the actuation element and is compressed during the actuation movement of the actuation element. As the actuation force drops, the return element is relieved of loading and returns the actuation element to its starting position. Owing to the spring return, the user receives haptic feedback after actuation has been performed.

The drive unit preferably also has a battery which supplies electrical energy to the drive motor.

The drive motor is preferably a linear motor or a rotary spindle motor. The drive motor preferably acts on the piston with a linearly shiftable actuator and correspondingly shifts the piston. At least one Hall sensor is preferably provided for detecting the position of the actuator. The at least one Hall sensor or parts thereof can be arranged on the abovementioned printed circuit board. In particular, the use of the linear motor is advantageous since the drive movement is performed without a step up or without a transmission here, this improving the motor dynamics.

In one variant, the drive unit is formed separately from the pipetting unit. The pipetting unit can then be operatively connected to the drive unit in such a way that the movement of the drive motor acts on the piston. The drive unit and the pipetting unit can be separated and accordingly a used pipetting unit can be replaced with an unused pipetting unit.

In another variant, the drive unit is integrally formed with the pipetting unit. That is to say, the drive unit and the pipetting unit cannot be separated.

The drive unit preferably comprises a control module. The signal of the sensor is transmitted to the control module here. The signal is processed in the control module and then transmitted to the drive motor as a processed signal.

In another embodiment, the mode switch does not limit the movement of the actuation element in the stepwise mode position. That is to say that the actuation element can be actuated over a partial distance of the maximum actuation travel or over the maximum actuation travel in the stepwise actuation mode.

A pipette assembly as claimed in claim 22 comprises a pipetting unit and a drive unit. The pipetting unit has a pipette housing with a cylinder chamber and a pipetting opening as well as a piston movably mounted in the cylinder chamber. The drive unit comprises a drive motor acting on the piston and moving the piston, an actuation element for specifying a movement of the piston, and a sensor assembly for detecting the movement of the actuation element and for providing a signal corresponding to the movement to the drive motor in such a way that the drive motor is controlled based on the signal and correspondingly acts on the piston. The actuation element can be actuated in a manual actuation mode in such a way that a pipetting volume which is proportional to the movement of the actuation element or which is proportional to the actuation travel of the actuation element can be dispensed. A push switch arranged separately from the actuation element is arranged for a stepwise actuation mode, wherein the push switch provides a control signal to the drive motor in such a way that a determined or identical pipetting volume is dispensed for each actuation of the push switch.

A pipetting assembly of this kind provides laboratory personnel with a flexibly usable pipetting assembly. Providing the push switch for the stepwise actuation mode has the advantage that a determined movement of the push switch can be performed, this improving the ergonomics of the pipetting assembly.

Further preferred embodiments of the pipetting assembly as claimed in claim 22 are described below:

The push switch is preferably arranged next to the actuation element, wherein the push switch and the actuation element each have an actuation surface. The actuation surfaces are preferably arranged adjoining each other.

The push switch can be formed in various ways. For example, the push switch may be an electromechanical push switch or it may be provided by an actuation panel in a touchscreen or it may be provided by an inductive or capacitive detection sensor.

In the manual actuation mode, the pipetting volume is proportional to the movement of the actuation element. That is to say, a volume corresponding to the actuation increment is dispensed for each actuation increment. The movement of the piston can correspond to the movement of the actuation element, or the movement of the piston can be stepped down or stepped up in relation to the movement of the actuation element.

When the piston moves away from the pipetting opening, a liquid can be drawn into the cylinder chamber through the pipetting opening, and when the piston moves in the direction of the pipetting opening, a liquid can be dispensed from the cylinder chamber through the pipetting opening.

The piston is, as mentioned, driven by the drive motor. Here, the drive motor moves the piston proportionally to the movement of the actuation element. Here, the movement of the actuation element can be transmitted to the piston, with a step up or a step down or with the same magnitude.

The actuation element can preferably be moved from a first starting position to a first end position in the manual actuation mode and the actuation element can be moved from a second starting position to a second end position in the stepwise actuation mode.

The actuation travel of the actuation element in the manual actuation mode is preferably greater than the movement travel of the push switch in the stepwise actuation mode. Consequently, the actuation movement by a finger of a user during the stepwise actuation mode turns out to be smaller than in the manual actuation mode. This has the advantage that the actuation is more ergonomic.

In the stepwise actuation mode, when actuation of the push switch is detected when the push switch is actuated, instead of the signal a predefined control signal is preferably output to the drive motor in such a way that a predefined pipetting volume, which is independent of the actuation travel of the actuation element, can be dispensed.

The predefined pipetting volume is preferably set via an input element. For example via a mechanically actuable input element, such as a rotary ring or a slide, or via an electronic input element, such as a switch or a touchscreen.

A pipetting volume which is correlated to the movement travel of the actuation element or which is proportional to the movement travel of the actuation element is dispensed in the manual actuation mode.

Further embodiments are specified in the dependent claims.

### BRIEF DESCRIPTION OF THE DRAWINGS

Preferred embodiments of the invention are described below with reference to the drawings, which serve solely for explanation and are not to be interpreted as restrictive. In the drawings:

FIG. 1 shows a schematic view of a pipette assembly according to one embodiment of the present invention;

FIG. 2a shows a schematic view of parts of a drive unit for the pipette assembly according to FIG. 1 in a manual actuation mode according to a first embodiment;

FIG. 2b shows the embodiment according to FIG. 2a in a stepwise actuation mode;

FIG. 2c shows a further schematic view of parts of the drive unit according to a development of the first embodiment of FIGS. 2a and 2c in the manual actuation mode;

FIG. 2d shows the embodiment according to FIG. 2c in a stepwise actuation mode;

FIG. 2e shows a locking mechanism for a mode switch for use in FIGS. 2a to 2d in the manual actuation mode;

FIG. 2f shows a locking mechanism for a mode switch for use in FIGS. 2a to 2e in the stepwise actuation mode;

FIG. 3a shows a schematic view of parts of a drive unit for the pipette assembly according to FIG. 1 in a manual actuation mode according to a second embodiment;

FIG. 3b shows the embodiment according to FIG. 3a in a stepwise actuation mode;

FIG. 4a shows a schematic view of parts of a drive unit for the pipette assembly according to FIG. 1 in a manual actuation mode according to a third embodiment;

FIG. 4b shows the embodiment according to FIG. 4a in a stepwise actuation mode;

FIG. 5a shows a schematic view of parts of a drive unit for the pipette assembly according to FIG. 1 in a manual actuation mode according to a fourth embodiment;

FIG. 5b shows the embodiment according to FIG. 4a in a stepwise actuation mode;

FIG. 6a shows a further variant of a drive unit for the pipette assembly according to FIG. 1 in a manual actuation mode; and

FIG. 6b shows the embodiment according to FIG. 6a in a stepwise actuation mode.

### DESCRIPTION OF PREFERRED EMBODIMENTS

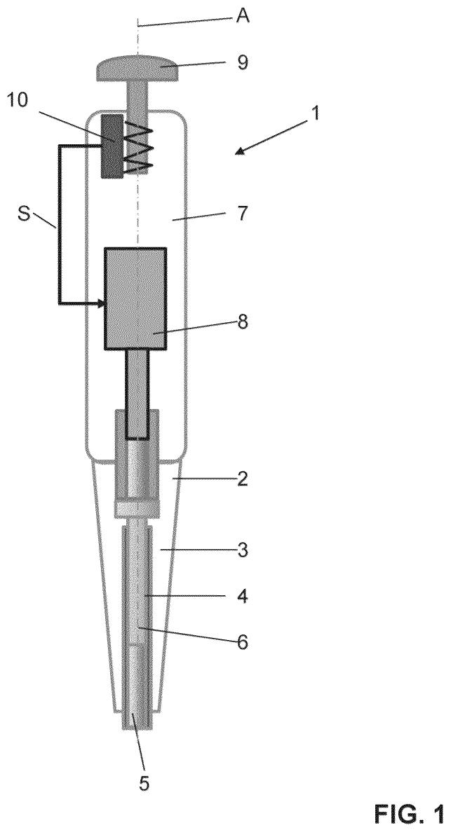

FIG. 1 shows a pipette assembly 1. The pipette assembly 1 comprises a pipetting unit 2 and a drive unit 7. The pipetting unit 2 and the drive unit 7 are separated from each other and can be connected to each other in the embodiment shown. In other embodiments, it is also conceivable for the pipetting unit 2 and the drive unit 7 to be integrally connected to each other.

The pipetting unit 2 has a pipette housing 3 with a cylinder chamber 4 and a pipetting opening 5 as well as a piston 6 movably mounted in the cylinder chamber 4. The piston 6 can be moved by the drive unit 7. During the movement of the piston 6 away from the pipetting opening 5, a liquid can be drawn into the cylinder chamber 4. During the movement of the piston 6 toward the pipetting opening 5, a liquid can be dispensed from the cylinder chamber 4.

The drive unit 7 has a drive motor 8, an actuation element 9 and a sensor assembly 10. The drive motor 8 acts on the piston 6 and thus the piston 6 can be moved in the cylinder chamber 4. The drive motor 8 provides a linear movement for the piston 6 here. A movement of the piston 6 can be specified by the actuation element 9. The specified movement of the actuation element 9 is detected by the sensor assembly 10. Here, the sensor assembly 10 provides a signal which corresponds to the movement of the actuation element 9. The signal is passed on to the drive motor 8 and the drive motor 8 is controlled based on the signal. The drive motor 8 acts on the piston 6 in accordance with the signal and in so doing the piston 6 is moved in accordance with the specified movement of the actuation element 9.

The drive motor 8 is preferably a linear motor and the sensor assembly comprises a sensor for detecting the movement of the actuation element 9, such as an induction-based sensor, an incremental sensor or an analog sensor for example.

The drive unit preferably also has a battery which supplies electrical energy to the drive motor and also the sensor assembly 10. The drive motor 8 can also have a position detection system which checks the position specified by the sensor assembly.

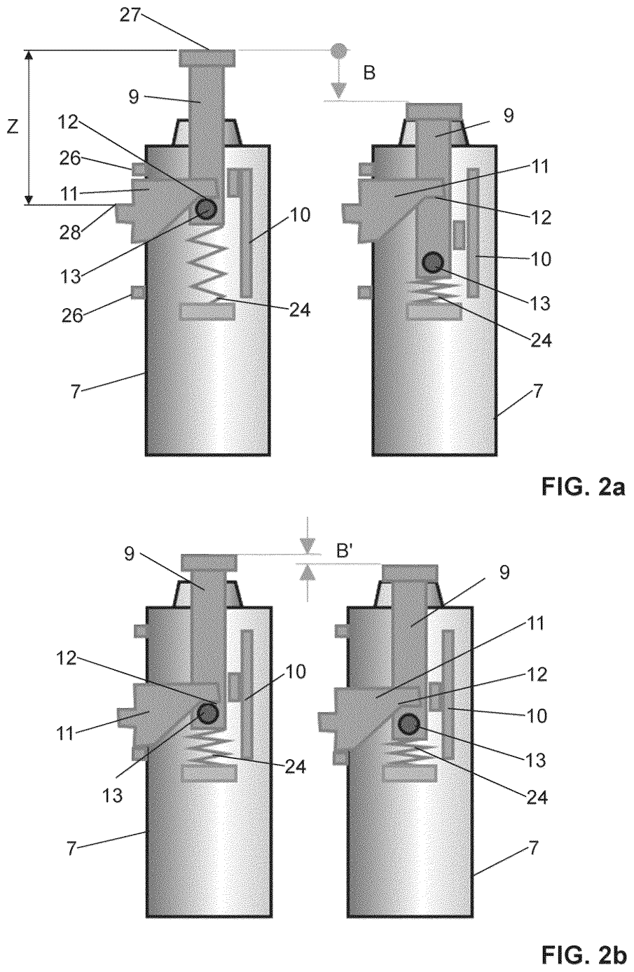

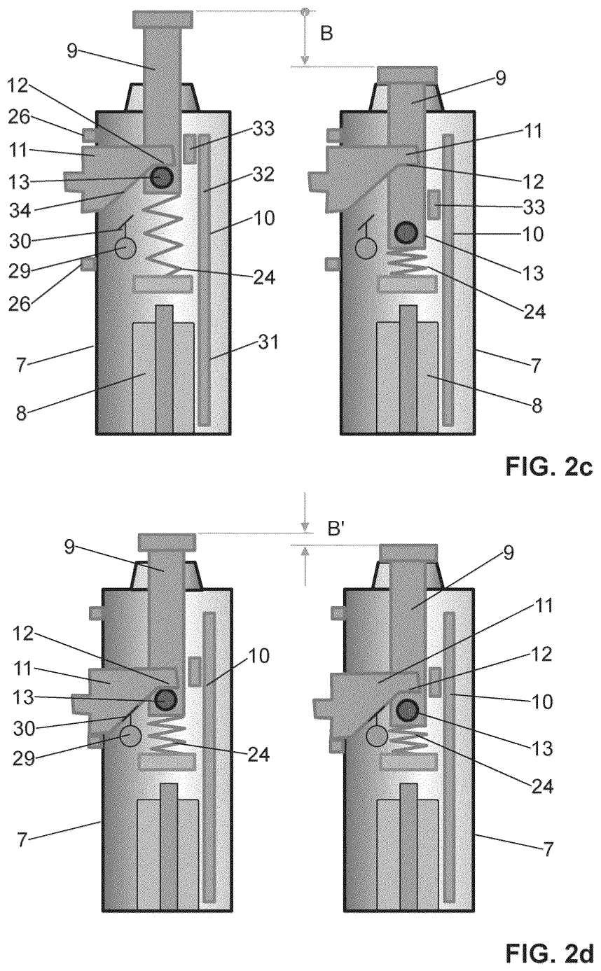

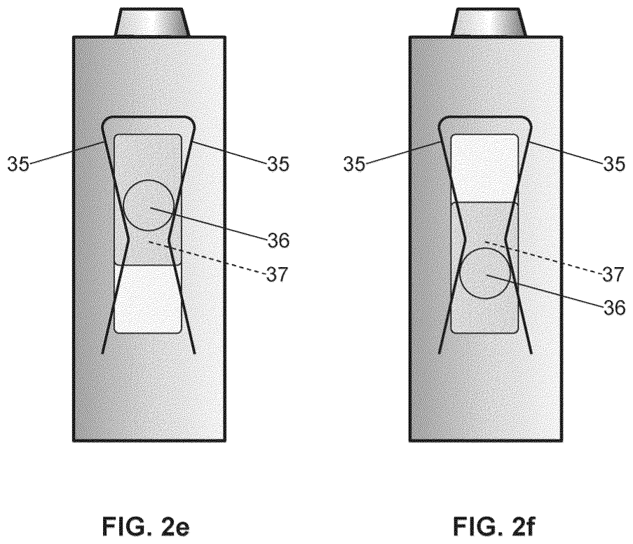

The drive unit 7 also has a mode switch 11 which can be shifted from a manual mode position to a stepwise mode position. When the mode switch 11 is in the manual mode position, the actuation element 9 can be actuated in a manual actuation mode in such a way that a pipetting volume which is correlated to the movement of the actuation element 9 can be dispensed. When the mode switch 11 is in the stepwise mode position, the actuation element 9 can be actuated in a stepwise actuation mode in such a way that a determined pipetting volume is dispensed for each actuation of the actuation element 9. Here, the mode switch 11 is designed in such a way that it limits the movement of the actuation element 9 in the stepwise mode position. The limiting is mechanical limiting in such a way that the actuation element 9 can only be moved over a limited actuation travel. Various embodiments are described below with reference to FIGS. 2a to 5b.

FIGS. 2a to 5b show various embodiments of a drive unit 7.

FIGS. 2a, 2c, 3a, 4a and 5a show the manual actuation mode. In the manual actuation mode, the actuation element 9 is moved from a first starting position, illustrated on the left in each case, in the direction of a first end position, illustrated on the right in each case. When the actuation element 9 covers the entire distance between the first starting position and the end position, the piston 6 is likewise actuated over its maximum travel. During the movement from the first starting position to the first end position, the piston 6 is moved in the direction of the pipetting opening 5. The liquid is dispensed from the cylinder chamber 4. During the movement from the first end position to the first starting position, the piston 6 is moved away from the pipetting opening 5 and the liquid is drawn into the cylinder chamber 4.

FIGS. 2b, 2d, 3b, 4b and 5b show the stepwise actuation mode. Here, the mode switch 11 is positioned in such a way that the actuation element 9 can be moved from a second starting position, shown on the left in each case, to a second end position, shown on the right in each case. The actuation travel between the second starting position and the second end position is preferably selected such that the movement feels as if the user is tapping a button.

In all of the embodiments of FIGS. 2a to 5b, the mode switch 11 has a mode switch-side stop surface 12. The actuation element 9 has an actuation element-side stop surface 13. When the mode switch 11 is in the stepwise mode position, the mode switch-side stop surface 12 is situated in such a way that the actuation element-side stop surface 13 stops against the mode switch-side stop surface 11. When the mode switch 11 is in the manual mode position, the mode switch-side stop surface 12 is situated in such a way that the actuation element-side stop surface 13 can be moved freely past the mode switch-side stop surface 12 or can be moved without interaction with the actuation element-side stop surface 13.

All of the embodiments of FIGS. 2 a to 5 b further show the maximum actuation travel B in the manual actuation mode and the maximum actuation travel B′ in the stepwise actuation mode. The maximum actuation travel B in the manual actuation mode is greater than the maximum actuation travel B′ in the stepwise actuation mode here. This is preferably the case with the proviso that the movement travel of the actuation element 9 in the stepwise actuation mode is greater than 0.5 millimeter. That is to say the actuation element is correspondingly moved in both modes.

In all of the embodiments, the mode switch 11 can preferably be latched with respect to the drive unit 7 via a latching element in the manual mode position. The mode switch 11 can preferably be latched with respect to the drive unit 7 and/or with respect to the actuation element 11 via a latching element in the stepwise mode position.

In all of the embodiments, the drive unit preferably has a spring-elastic return element 24 which acts on the actuation element 9. The spring-elastic return element 24 ensures that the actuation element is returned to the first or the second starting position as an actuation force drops.

The actuation element 9 is preferably moved along a respective movement travel both in the manual actuation mode and also in the stepwise actuation mode. The movement travel runs in the same direction in the manual actuation mode and in the stepwise actuation mode. In particular, the movement travel of the actuation element 9 runs along a rectilinearly oriented axis A in the manual actuation mode and in the stepwise actuation mode. The axis A preferably runs colinearly in relation to the movement of the piston 6.

The actuation element 7 and the mode switch 11 are preferably situated relative to each other in such a way that a user can actuate both the actuation element 7 and also the mode switch 11 with the same finger, typically with the thumb. The actuation element 7 preferably has an actuation element-side actuation surface 27 and the mode switch 11 has a mode switch-side actuation surface 28. When the actuation element 9 is unactuated and the mode switch 11 is preferably in the manual mode position, the mode switch-side actuation surface 28 lies at a distance Z of at most 80 millimeters from the actuation element-side actuation surface 27, as seen in the direction of the actuation movement of the actuation element 9. The distance Z is shown in FIG. 2A. The distance Z can be provided in all of the embodiments according to FIGS. 1 to 5b described herein.

In the first embodiment according to FIGS. 2a and 2b, the position of the first end position is the same as the position of the second end position. The position of the first starting position lies at a greater distance from the first or second end position than the position of the second starting position. Here, the mode switch 11 is shifted such that the position of the first starting position and the position of the second starting position are different from each other.

The mode switch 11 is shifted from the manual mode position to the stepwise mode position in a direction parallel or virtually parallel to the actuation direction of the actuation element 9. In the stepwise mode position, the mode switch-side stop surface 12 limits the movement of the actuation element 9. The mode switch-side stop surface 12 preferably provides a stop for the actuation element 9 both in the first starting position for the manual actuation mode and also in the second starting position for the stepwise actuation mode. When the mode switch 11 is actuated, the mode switch-side stop surface 12 can be brought into contact with the actuation element-side stop surface 13. Owing to this contact, the actuation element 9 can be moved from the first starting position for the manual actuation mode to the second starting position for the stepwise actuation mode. Looking at FIGS. 2a to 2d, it is clear that the mode switch 11, when it is actuated, moves the actuation element 9 downward.

In the embodiment shown, the movement of the mode switch 11 is limited by stops 26.

FIGS. 2c and 2d show that the pipette assembly 1 comprises a further sensor assembly 29. The further sensor assembly 29 comprises a sensor 30 which is configured and arranged in such a way that the position of the mode switch 11 can be detected, and that a control signal corresponding to the position can be provided to the drive motor 8. In the embodiment shown, the sensor 30 is an electrical switch which is actuated by a contact edge 34 on the mode switch 11. The further sensor assembly 29 can also be provided in all other embodiments.

FIGS. 2c and 2d further illustrate that the pipette assembly 1 also has a printed circuit board 31. Here, the printed circuit board 31 is arranged laterally adjacent to the drive motor 8. Said sensor assembly 10 for detecting the movement of the actuation element 9 comprises an active sensor element 32 and a passive sensor element 33 here. The active sensor element 32 is arranged on the printed circuit board 31 and the passive sensor element 33 is arranged on the actuation element 9 here. The sensor 30, here the switch, of the further sensor assembly 29 is particularly preferably likewise arranged on said printed circuit board 31. The printed circuit board 31 can also be provided in all other embodiments.

FIGS. 2e and 2f show a preferred latching mechanism of the mode switch 11. Two spring clips 35 are provided here, the mode switch 11 with a latching cam 36 being moved by the two spring clips. The spring clips have an intermediate space 37 which has a smaller cross section than the diameter of the latching cam 36. When the mode switch 11 moves, the latching cam 36 slides through the intermediate space, wherein a force has to be exerted onto the mode switch 11, this force being such that the two spring clips move away from each other, so that the latching cam can pass the intermediate space 37.

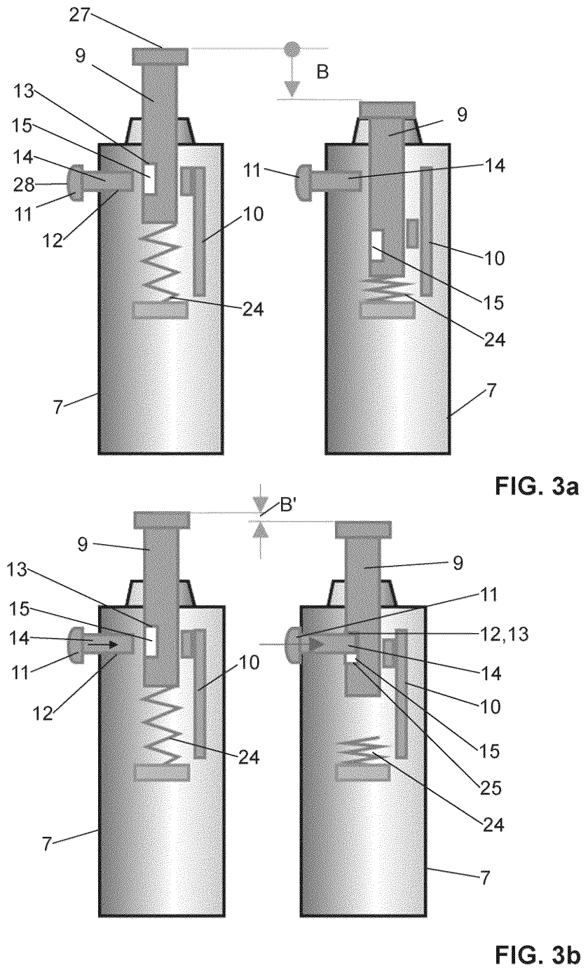

In the second embodiment according to FIGS. 3a and 3b, the position of the first starting position is the same as the position of the second starting position. The position of the first end position lies at a greater distance from the first or second starting position than the position of the second end position. Here, the mode switch 11 is shifted such that the position of the first end position and the position of the second end position are different from each other.

In the second embodiment, the mode switch 11 can be shifted from the manual mode position to the stepwise mode position in a direction transverse or virtually transverse to the actuation direction of the actuation element 9.

In the preferred embodiment shown, the mode switch 11 has a rod-like portion 14 which engages into a corresponding opening 15 on the actuation element 9. The corresponding opening 15 has an extent in the direction of actuation of the actuation element 9 that is greater than the cross section of the rod-like portion. Here, the opening 15 provides the actuation element-side stop surface 13 and the rod-like portion has the mode switch-side stop surface 12.

In the embodiment shown, the opening 15 provides a further stop surface 25 which is at a distance from the actuation element-side stop surface 13. The further stop surface 25 can likewise be brought into contact with the rod-like portion 14. The distance between the two stop surfaces 13, 25 specifies the maximum actuation travel B′.

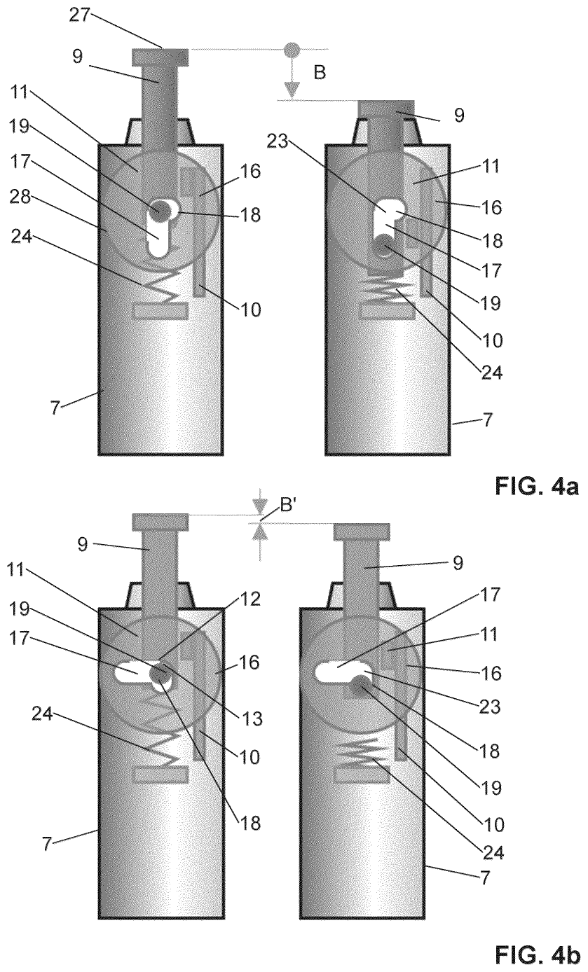

In the third embodiment according to FIGS. 4a and 4b, the position of the first starting position is the same as the position of the second starting position. The position of the first end position lies at a greater distance from the first or second starting position than the position of the second end position. Here, the mode switch 11 is shifted such that the position of the first end position and the position of the second end position are different from each other.

The mode switch 11 is a rotary disk 16. The rotary disk 16 has a first groove 17 and a second groove 18. The two grooves 17, 18 run inclined in an angled manner at an angle in relation to each other. The angle is 90° here. However, the angle may also be larger or smaller. The actuation element 9 has a pin 19 which projects into the grooves 17, 18. The grooves 17, 18 have different lengths in such a way that said movement limiting can be provided. The groove 18 provides said mode switch-side stop surface 12.

The angle between the two grooves 17, 18 specifies a pivot angle for the rotary disk in such a way that the grooves 17, 18 run parallel to the direction of actuation of the actuation element in the respective mode position. The grooves 17, 18 intersect at the center of rotation 23 of the rotary disk 16 and when the pin 19 lies at the point of intersection or at the center of rotation 23, the rotary disk 16 can be shifted from the manual mode position to the stepwise mode position.

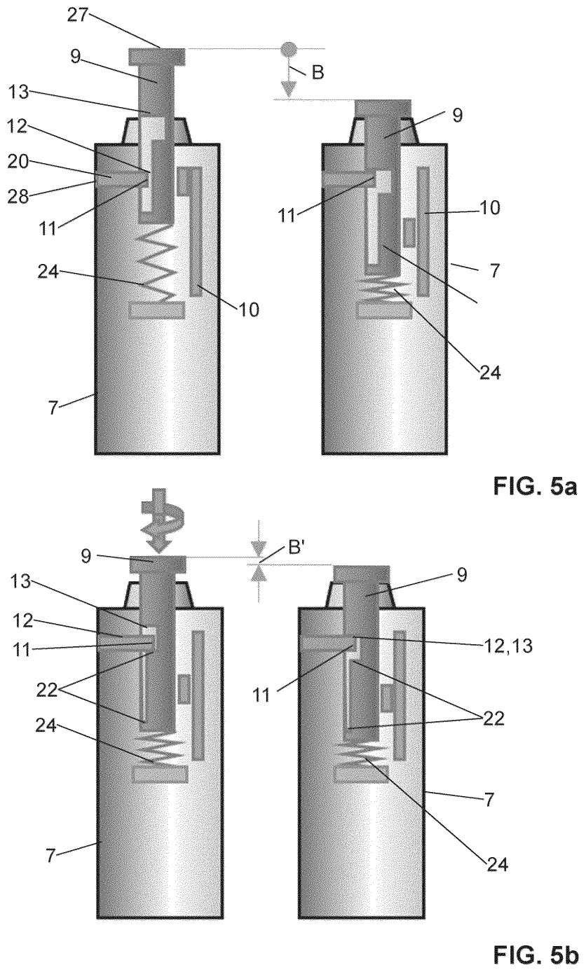

In the fourth embodiment according to FIGS. 5a and 5b, the position of the first end position is the same as the position of the second end position. The position of the first starting position lies at a greater distance from the first or second end position than the position of the second starting position. Here, the mode switch 11 is shifted such that the position of the first starting position and the position of the second starting position are different from each other.

the fourth embodiment, the mode switch 11 has a rigid shaft 20. The rigid shaft 20 engages into a receptacle 21 arranged on the actuation element 9, wherein the receptacle 21 has a region for the manual actuation mode and a region for the stepwise actuation mode. The two regions can be brought into an interacting position with the shaft 20 by pivoting the actuation element 9 about the axis along which the actuation element 9 is actuated. The receptacle provides, at one end of the respective regions, the mode switch-side stop surface 12. The other ends of the respective regions likewise act as stop surfaces. These stop surfaces bear the reference sign 22.

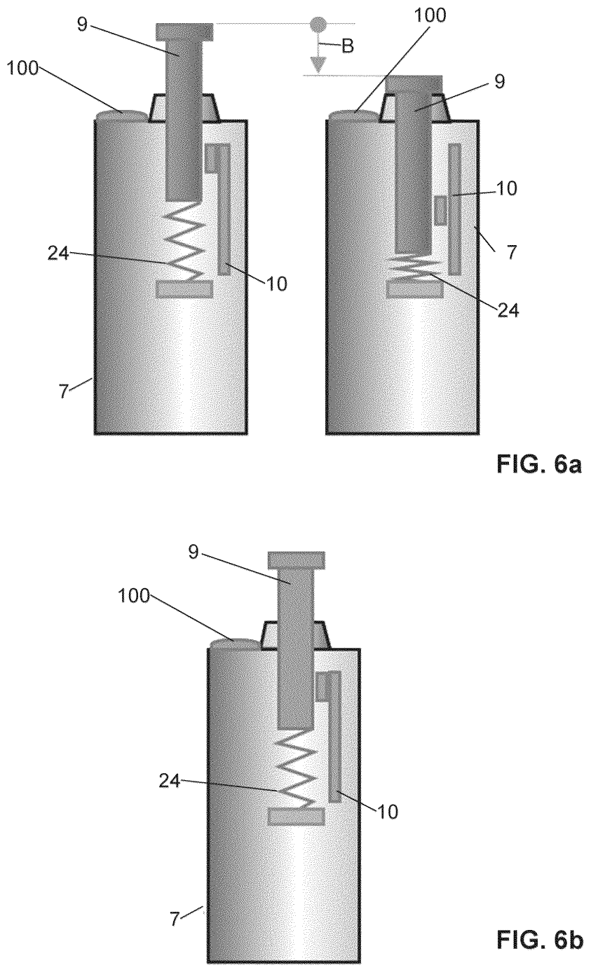

FIGS. 6a and 6b show a further pipette assembly 1. This pipette assembly differs from the pipette assembly according to the preceding figures substantially in that instead of the mode switch a push switch 100 is provided for the stepwise actuation mode. The pipette assembly 1 comprises a pipetting unit 2 and a drive unit 7. The pipetting unit 2 and the drive unit 7 are separated from each other and can be connected to each other in the embodiment shown. In other embodiments, it is also conceivable for the pipetting unit 2 and the drive unit 7 to be integrally connected to each other.

The pipetting unit 2 has a pipette housing 3 with a cylinder chamber 4 and a pipetting opening 5 as well as a piston 6 movably mounted in the cylinder chamber 4. The piston 6 can be moved by the drive unit 7. When the piston 6 moves away from the pipetting opening 5, a liquid can be drawn into the cylinder chamber 4. During the movement of the piston 6 toward the pipetting opening 5, a liquid can be dispensed from the cylinder chamber 4.

The drive unit 7 has a drive motor 8, an actuation element 9 and a sensor assembly 10. The drive motor 8 acts on the piston 6 and thus the piston 6 can be moved in the cylinder chamber 4. The drive motor 8 provides a linear movement for the piston 6 here. A movement of the piston 6 can be specified by the actuation element 9. The specified movement of the actuation element 9 is detected by the sensor assembly 10. Here, the sensor assembly 10 provides a signal which corresponds to the movement of the actuation element 9. The signal is passed on to the drive motor 8 and the drive motor 8 is controlled based on the signal. The drive motor 8 acts on the piston 6 in accordance with the signal and in so doing the piston 6 is moved in accordance with the specified movement of the actuation element 9. The drive unit 7 further has a push switch 100 arranged separately from the actuation element 9 for the stepwise actuation mode. The push switch provides a control signal to the drive motor in such a way that a determined pipetting volume is dispensed for each actuation of the push switch 100.

### LIST OF REFERENCE SIGNS

1 Pipette assembly 33 Passive sensor element
2 Pipetting unit 34 Contact edge
3 Pipette housing 35 Spring clip
4 Cylinder chamber 36 Latching cam
5 Pipetting opening 100 Push button
6 Piston A Axis
7 Drive unit B Actuation travel
8 Drive motor B′ Actuation travel
9 Actuation element S Signal
10 Sensor assembly Z Distance
11 Mode switch
12 Mode switch-side stop surface
13 Actuation element-side stop surface
14 Rod-like portion
15 Opening
16 Rotary disk
17 First groove
18 Second groove
19 Pin
20 Stop
21 Receptacle
22 Stop surfaces
23 Center of rotation
24 Return element
25 Further stop surface
26 Stop
27 Actuation surface of 7
28 Actuation surface of 11
29 Further sensor assembly
30 Sensor
31 Printed circuit board
32 Active sensor element

1-24. (canceled)

25. A pipette assembly comprising,
a pipetting unit, which has a pipette housing with a cylinder chamber and a pipetting opening as well as a piston movably mounted in the cylinder chamber, and
a drive unit comprising:
a drive motor acting on the piston and moving the piston,
an actuation element for specifying a movement of the piston, and
a sensor assembly for detecting the movement of the actuation element and for providing a signal corresponding to the movement to the drive motor in such a way that the drive motor is controlled based on the signal and correspondingly acts on the piston,
wherein the drive unit also has a mode switch which can be shifted from a manual mode position to a stepwise mode position in such a way
that, when the mode switch is in the manual mode position, the actuation element can be actuated in a manual actuation mode in such a way that a pipetting volume which is proportional to the movement of the actuation element can be dispensed, and
that, when the mode switch is in the stepwise mode position, the actuation element can be actuated in a stepwise actuation mode in such a way that a determined pipetting volume is dispensed for each actuation of the actuation element.

26. The pipette assembly as claimed in claim 25, wherein the mode switch limits the movement of the actuation element in the stepwise mode position.

27. The pipette assembly as claimed in claim 25, wherein the actuation element can be moved from a first starting position to a first end position in the manual actuation mode;
and in that the actuation element can be moved from a second starting position to a second end position in the stepwise actuation mode.

28. The pipette assembly as claimed in claim 27, wherein the position of the first starting position is the same as the position of the second starting position, and the position of the first end position lies at a greater distance from the starting position than the position of the second end position; or
in that the position of the first end position is the same as the position of the second end position, and the position of the first starting position lies at a greater distance from the end position than the position of the second starting position; or
in that the position of the first starting position is different from the position of the second starting position and the position of the first end position is different from the position of the first starting position, wherein the position of the second starting position and the position of the second end position lies between the position of the first starting position and the first end position.

29. The pipette assembly as claimed in claim 25, wherein the actuation travel of the actuation element in the manual actuation mode is greater than the movement travel of the actuation element in the stepwise actuation mode, this preferably being the case with the proviso that the movement travel of the actuation element in the stepwise actuation mode is greater than 0.5 millimeter.

30. The pipette assembly as claimed in claim 25, wherein the actuation element is movable or is moved along a respective movement travel both in the manual actuation mode and also in the stepwise actuation mode,
wherein the movement travel runs in the same direction in the manual actuation mode and in the stepwise actuation mode; and/or
wherein the movement travel of the actuation element takes place along a rectilinearly oriented axis in the manual actuation mode and in the stepwise actuation mode.

31. The pipette assembly as claimed in claim 25, wherein, in the stepwise actuation mode, when a movement of the actuation element is detected by the sensor assembly when the actuation element is actuated, instead of the signal a predefined control signal is output to the drive motor in such a way that a predefined pipetting volume, which is independent of the actuation travel of the actuation element, can be dispensed.

32. The pipette assembly as claimed in claim 25, wherein the mode switch has a mode switch-side stop surface and the actuation element has an actuation element-side stop surface,
wherein, when the mode switch is in the stepwise mode position, the mode switch-side stop surface is situated in such a way that the actuation element-side stop surface stops against the mode switch-side stop surface, and
wherein, when the mode switch is in the manual mode position, the mode switch-side stop surface is situated in such a way that the actuation element-side stop surface can be moved freely past the mode switch-side stop surface or can be moved without interaction with the actuation element-side stop surface; or
wherein, when the mode switch is in the manual mode position, the mode switch-side stop surface is situated in such a way that the actuation element-side stop surface stops against the mode switch-side stop surface only in an upper end position of the actuation element.

33. The pipette assembly as claimed in claim 25,
wherein the actuation element has an actuation element-side actuation surface,
wherein the mode switch has a mode switch-side actuation surface, and
wherein, when the actuation element is unactuated and the mode switch is preferably in the manual mode position, the mode switch-side actuation surface lies at a distance of at most 80 millimeters from the actuation element-side actuation surface, as seen in the direction of the actuation movement of the actuation element.

34. The pipette assembly as claimed in claim 25, wherein the pipette assembly comprises a further sensor assembly, wherein the further sensor assembly has a sensor, wherein the sensor is configured and arranged in such a way that the position of the mode switch can be detected, and wherein a control signal corresponding to the position can be provided to the drive motor.

35. The pipette assembly as claimed in claim 25, wherein the pipette assembly also has a printed circuit board which is arranged laterally adjacent to the drive motor,
wherein said sensor assembly for detecting the movement of the actuation element has an active sensor element and a passive sensor element, wherein the active sensor element is arranged on the printed circuit board and the passive sensor element is arranged on the actuation element.

36. The pipette assembly as claimed in claim 25,
wherein the pipette assembly comprises a further sensor assembly, wherein the further sensor assembly has a sensor, wherein the sensor is configured and arranged in such a way that the position of the mode switch can be detected, and wherein a control signal corresponding to the position can be provided to the drive motor;
wherein the pipette assembly also has a printed circuit board which is arranged laterally adjacent to the drive motor,
wherein said sensor assembly for detecting the movement of the actuation element has an active sensor element and a passive sensor element, wherein the active sensor element is arranged on the printed circuit board and the passive sensor element is arranged on the actuation element; and
wherein the sensor of the further sensor assembly is arranged on said printed circuit board.

37. The pipette assembly as claimed in claim 25, wherein the mode switch can be shifted from the manual mode position to the stepwise mode position in a direction virtually parallel or parallel to the actuation direction of the actuation element.

38. The pipette assembly as claimed in claim 37, wherein the mode switch-side stop surface can be shifted in said direction, and in that the mode switch-side stop surface provides a stop for the actuation element both in the first starting position for the manual actuation mode and also in the second starting position for the stepwise actuation mode.

39. The pipette assembly as claimed in claim 37, wherein, when the mode switch is actuated, the mode switch-side stop surface can be brought into contact with the actuation element-side stop surface, and in that, owing to this contact, the actuation element can be moved from a starting position for the manual actuation mode to a starting position for the stepwise actuation mode.

40. The pipette assembly as claimed in claim 25, wherein the mode switch can be shifted from the manual mode position to the stepwise mode position in a direction virtually transverse or transverse to the actuation direction of the actuation element.

41. The pipette assembly as claimed in claim 25, wherein the mode switch can be shifted from the manual mode position to the stepwise mode position in a direction inclined in an angled manner in relation to the actuation direction of the actuation element.

42. The pipette assembly as claimed in claim 25, wherein the mode switch is a rotary disk, which rotary disk has a first groove and a second groove which runs inclined in an angled manner in relation to the first groove, wherein the actuation element has a pin which projects into the grooves, and wherein the grooves have different lengths in such a way that said movement limiting can be provided.

43. The pipette assembly as claimed in claim 25, wherein the mode switch has a rigid shaft which engages into a receptacle arranged on the actuation element, wherein the receptacle has a region for the manual actuation mode and a region for the stepwise actuation mode, wherein the two regions can be brought into an interacting position with the shaft by pivoting the actuation element about the axis along which the actuation element is actuated.

44. The pipette assembly as claimed in claim 25, wherein the mode switch can be latched with respect to the drive unit via a latching element in the manual mode position; and/or the mode switch can be latched with respect to the drive unit and/or with respect to the actuation element via a latching element in the stepwise mode position.

45. The pipette assembly as claimed in claim 25, wherein the mode switch does not limit the movement of the actuation element in the stepwise mode position in such a way that the actuation element can be actuated over a partial distance of the maximum actuation travel or over the maximum actuation travel in the stepwise actuation mode.

46. The pipette assembly comprising
a pipetting unit which has a pipette housing with a cylinder chamber and a pipetting opening as well as a piston movably mounted in the cylinder chamber, and
a drive unit having
a drive motor acting on the piston,
an actuation element for specifying a movement of the piston, and
a sensor assembly for detecting the movement of the actuation element and for providing a signal corresponding to the movement to the drive motor in such a way that the drive motor is controlled based on the signal,
wherein the actuation element can be actuated in a manual actuation mode in such a way that a pipetting volume which is proportional to the movement of the actuation element can be dispensed, and
wherein a push switch arranged separately from the actuation element is arranged for a stepwise actuation mode, wherein the push switch provides a control signal to the drive motor in such a way that a determined pipetting volume is dispensed for each actuation of the push switch.

47. The pipette assembly as claimed in claim 46, wherein the push switch is arranged next to the actuation element, wherein the push switch and the actuation element each have an actuation surface, which actuation surfaces are preferably arranged adjoining each other.

48. A method for operating a pipette assembly,
which pipette assembly comprising
a pipetting unit, which has a pipette housing with a cylinder chamber and a pipetting opening as well as a piston movably mounted in the cylinder chamber, and
a drive unit comprising
a drive motor acting on the piston and moving the piston,
an actuation element for specifying a movement of the piston, and
a sensor assembly for detecting the movement of the actuation element and for providing a signal corresponding to the movement to the drive motor in such a way that the drive motor is controlled based on the signal and correspondingly acts on the piston,
wherein the drive unit also has a mode switch which can be shifted from a manual mode position to a stepwise mode position in such a way
that, when the mode switch is in the manual mode position, the actuation element can be actuated in a manual actuation mode in such a way that a pipetting volume which is proportional to the movement of the actuation element can be dispensed, and
that, when the mode switch is in the stepwise mode position, the actuation element can be actuated in a stepwise actuation mode in such a way that a determined pipetting volume is dispensed for each actuation of the actuation element,
wherein the mode switch is moved to a stepwise mode position in a step for activating the stepwise actuation mode; and wherein the mode switch is moved to a manual mode position in a step for activating the manual actuation mode.

49. A method for operating a pipette assembly,
which pipette assembly comprising
a pipetting unit which has a pipette housing with a cylinder chamber and a pipetting opening as well as a piston movably mounted in the cylinder chamber, and
a drive unit having
a drive motor acting on the piston,
an actuation element for specifying a movement of the piston, and
a sensor assembly for detecting the movement of the actuation element and for providing a signal corresponding to the movement to the drive motor in such a way that the drive motor is controlled based on the signal,
wherein the actuation element can be actuated in a manual actuation mode in such a way that a pipetting volume which is proportional to the movement of the actuation element can be dispensed, and
wherein a push switch arranged separately from the actuation element is arranged for a stepwise actuation mode, wherein the push switch provides a control signal to the drive motor in such a way that a determined pipetting volume is dispensed for each actuation of the push switch
wherein the mode switch is moved to a stepwise mode position in a step for activating the stepwise actuation mode; and wherein the mode switch is moved to a manual mode position in a step for activating the manual actuation mode.
